(19) United States
(12) Patent Application Publication
(10) Pub. No.: US 2024/0403847 A1
(43) Pub. Date: Dec. 5, 2024

(54) SYSTEMS, DEVICES, AND METHODS FOR SELF-CHECKOUT MONITORING

(71) Applicant: VeriFone, Inc., Wilmington, DE (US)

(72) Inventors: Sumith S Sunder, Kottayam (IN); Pravija K, Calicut (IN); Channakeshava V P, Tumkur (IN); Ashish K Nair, Bengaluru (IN); Alan Luna, New Port Richey, FL (US); Bhanu Raghuraman Aiyar, Chennai (IN); Vandana Susheela Mandir, Bangalore (IN)

(73) Assignee: VeriFone, Inc., Wilmington, DE (US)

(21) Appl. No.: 18/697,140

(22) PCT Filed: Sep. 26, 2022
(86) PCT No.: PCT/US2022/076991

§ 371 Date: Mar. 29, 2024

(30) Foreign Application Priority Data
Oct. 1, 2021 (IN) 202111044624

(51) Int. Cl. G06Q 20/18; G06Q 20/20; G06Q 30/0601

(52) U.S. Cl. CPC G06Q 20/18; G06Q 20/202; G06Q 30/0607

(57) ABSTRACT

A self-checkout monitoring system including self-checkout terminals, a site controller, and point-of-sale devices, is provided. A self-checkout terminal receives a transaction event, generates a transaction status update based on this transaction event, and transmits the transaction status up-date to a site controller, which routes the transaction status update to a point-of-sale device. The point-of-sale device generates a transaction status icon based on the transaction status update and displays a self-checkout monitoring panel with a status tile displaying the status icon corresponding to the transaction status update most recently received from the self-checkout terminal. The cashier selects the self-checkout terminal by entering a self-checkout terminal selection input causing the point-of-sale device to display transaction control commands. The cashier chooses a transaction control command to apply to the self-checkout terminal. The transaction control command is then transmitted, via the site controller, to the self-checkout terminal to configure the self-checkout terminal accordingly.

### CROSS-REFERENCE TO RELATED APPLICATIONS

This application claims priority to Indian patent application No. 202111044624, filed Oct. 1, 2021, and entitled “A Systems, Devices, and Methods for Self-Checkout Monitoring”, the entirety of which is incorporated herein by reference.

### FIELD OF THE DISCLOSURE

The present disclosure is directed generally to systems, devices, and methods for monitoring self-checkout terminals in retail store environments.

### BACKGROUND

Self-checkout terminals can be implemented in retail stores, such as convenience stores, to reduce labor costs and customer checkout wait times. However, self-checkout terminals come with challenges in checkout management and customer service. Accordingly, there is a need in the art for self-checkout terminals to enable the provision of customer assistance when required.

### SUMMARY OF THE DISCLOSURE

The present disclosure is directed to self-checkout monitoring. The self-checkout monitoring systems, devices, and methods disclosed herein include self-checkout terminals, a site controller, and point-of-sale devices. The systems and methods enable monitoring of the self-checkout terminals via the point-of-sale devices, as well as by handheld terminals and store manager devices. The systems and methods also enable cashiers, managers, and other staff members to remotely control aspects of the self-checkout terminals. In this way, the self-checkout monitoring system (1) alerts staff members to customer issues related to the self-checkout terminals, and (2) enables the staff members to address the customer issues without leaving their current location.

A self-checkout terminal of the self-checkout monitoring system receives a transaction event from a customer. The self-checkout terminal generates a transaction status update based on this transaction event and the corresponding self-checkout terminal. The self-checkout terminal then transmits the transaction status update to a site controller. The site controller routes the transaction status update to a point-of-sale device. Upon receiving the transaction status update, the point-of-sale device generates a transaction status icon based on the transaction status update. The point-of-sale device displays a self-checkout monitoring panel with a plurality of status tiles. Each status tile corresponds to a self-checkout terminal in the self-checkout monitoring system, and displays the status icon corresponding to the transaction status update most recently received from the self-checkout terminal. The cashier can select one of the status tiles corresponding to a self-checkout terminal by entering a self-checkout terminal selection input. This input causes the point-of-sale device to display a plurality of transaction control commands. The cashier can then choose a transaction control command to apply to the selected self-checkout terminal. The chosen transaction control command is then transmitted, via the site controller, to the appropriate self-checkout terminal. The transaction control command then configures the self-checkout terminal accordingly.

Generally, in one aspect, a point-of-sale device is provided. The point-of-sale device includes a processor. The processor is configured to receive a transaction status update. The transaction status update corresponds to one of one or more self-checkout terminals. The processor may receive the transaction status update via a site controller.

The processor is further configured to generate a transaction status icon. The transaction status icon corresponds to the transaction status update. According to an example, the transaction status update is one of non-sales, idle, customer check-in, sales, help request, help request and sales, age restricted sale, cashier log-in, lane closed, offline, payment failure, and suspended.

The processor is further configured to display a self-checkout monitoring panel. The self-checkout monitoring panel includes one or more status tiles. Each of the one or more status tiles corresponds to one of the one or more self-checkout terminals. Each of the status tiles is configured to display the transaction status icon of the corresponding self-checkout terminal.

The processor is further configured to display, upon receiving a self-checkout terminal selection input, one or more transaction control commands in a detail view panel. According to an example, the one or more transaction control commands include at least one of attend, scan, approve, decline, and suspend. According to an additional example, the detail view panel further comprises at least one of product name, product quantity, and amount due.

The processor is further configured to transmit, upon receiving a transaction control command selection, one of the one or more transaction control commands to the corresponding self-checkout terminal.

According to an example, the processor is further configured to receive image data. The image data corresponds to one of the one or more self-checkout terminals. The detail view panel may further include at least a portion of the image data.

According to an example, the processor is further configured to display a utility panel. The utility panel is configured to display one or more selectable filter tiles. The utility panel is further configured to display a subset of the status tiles displayed in the self-checkout monitoring panel. The subset of the status tiles are displayed according to a filter selection. The filter selection corresponds to one of the one or more selectable filter tiles.

Generally, in another aspect, a self-checkout monitoring system is provided. The self-checkout monitoring system includes one or more self-checkout terminals, a site controller, and one or more point-of-sale devices.

The site controller comprises a processor. The processor of the site controller is configured to receive a transaction status update. The transaction status update corresponds to a first self-checkout terminal. The processor of the site controller is further configured to transmit the transaction status update to each of the one or more point-of-sale devices. The processor of the site controller is further configured to receive a transaction control command from a first point-of-sale device. The processor of the site controller is further configured to transmit the transaction control command to the first self-checkout terminal.

According to an example, the processor of the site controller is further configured to generate a transaction record. The transaction record corresponds to the transaction control command, the first self-checkout terminal, and the first point-of-sale device. The processor may be further configured to transmit the transaction record to a store manager device. The store manager device may be located remotely relative to the one or more self-checkout terminals and the one or more point-of-sale devices.

According to an example, the processor of the site controller is further configured to transmit the transaction status update to a handheld terminal. The processor of the site controller may be further configured to receive a handheld transaction control command from the handheld terminal. The processor of the site controller may be further configured to transmit the handheld transaction control command to the first self-checkout terminal.

According to an example, the processor of the site controller is further configured to generate a transaction record. The transaction record corresponds to the handheld transaction control command, the first self-checkout terminal, and the handheld terminal.

According to an example, the self-checkout monitoring system further includes a camera. configured to provide image data corresponding to the first self-checkout terminal to the site controller. The processor of the site controller is further configured to provide the image data to the first point-of-sale device.

Generally, in another aspect, a self-checkout terminal is provided. The self-checkout terminal includes a processor configured to generate a transaction status update. The transaction status update is based on a transaction event. According to an example, the transaction event is an age-restricted sale. According to an alternate example, the transaction event is a help request.

The processor of the self-checkout terminal is further configured to provide the transaction status update to a site controller.

The processor of the self-checkout terminal is further configured to receive, from the site controller, a transaction control command corresponding to the transaction status update. According to an example, the site controller receives the transaction control command from a point-of-sale device.

The processor of the self-checkout terminal is further configured to configure the self-checkout terminal based on the transaction control command.

In various implementations, a processor or controller may be associated with one or more storage media (generically referred to herein as “memory,” e.g., volatile and non-volatile computer memory such as RAM, PROM, EPROM, EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a diagram of a self-checkout monitoring system, in accordance with an example.

FIG. 2 is an illustration of a display screen of a point-of-sale device, in accordance with an example.

FIGS. 3A-3K are illustrations of various transaction status icons, in accordance with several examples.

FIG. 4 is an illustration of a detail view panel as shown on a point-of-sale device screen, in accordance with an example.

FIG. 5 is a schematic diagram of a point-of-sale device, in accordance with an example.

FIG. 6 is a schematic diagram of a site controller, in accordance with an example.

FIG. 7 is a schematic diagram of a self-checkout terminal, in accordance with an example.

FIG. 8 is a flowchart of a method for self-checkout monitoring, in accordance with an example.

### DETAILED DESCRIPTION OF EMBODIMENTS

The self-checkout monitoring systems, devices, and methods of the present disclosure include self-checkout terminals, a site controller, and point-of-sale devices. The systems and methods enable monitoring of the self-checkout terminals via the point-of-sale devices, as well as by handheld terminals and store manager devices. The systems and methods also enable cashiers, managers, and other store staff to remotely control aspects of the self-checkout terminals. In this way, the self-checkout monitoring system (1) alerts store staff to customer issues related to the self-checkout terminals, and (2) enables the store staff to address the customer issues without leaving their current location.

A self-checkout terminal of the self-checkout monitoring system receives a transaction event from a customer. This transaction event could correspond to a wide array of actions, including purchasing a standard item. Alternatively, the transaction event could include an action requiring staff intervention, such as a help request or a purchase of an age-restricted item (such as alcohol or tobacco products). The self-checkout terminal generates a transaction status update based on this transaction event and the corresponding self-checkout terminal. The self-checkout terminal then transmits the transaction status update to a site controller. The site controller routes the transaction status update to a point-of-sale device.

Upon receiving the transaction status update, the point-of-sale device generates a transaction status icon based on the transaction status update. The point-of-sale device displays a self-checkout monitoring panel with a plurality of status tiles. Each status tile corresponds to a self-checkout terminal in the self-checkout monitoring system, and displays the status icon corresponding to the transaction status update most recently received from the corresponding self-checkout terminal. Accordingly, the self-checkout monitoring panel enables a cashier to determine the status of every self-checkout terminal quickly and easily.

The self-checkout monitoring panel also enables the cashier to control aspects of the self-checkout terminals from the point-of-sale device. The cashier can select one of the status tiles correspond to a self-checkout terminal by entering a self-checkout terminal selection input. This input causes the point-of-sale device to display a plurality of transaction control commands, such as attend, approve, decline, and/or suspend, in a detail view panel. The detail view panel can contain additional information relevant to the corresponding transaction status update, such as product name, quantity, and/or price. The cashier can then choose a transaction control command to apply to the selected self-checkout terminal.

The detail view panel can also display image data, such as still images or video, captured by a camera corresponding to the selected self-checkout terminal. The cashier can then use this image data to select an appropriate self-checkout command. Further, the customer can use the camera to provide information to the cashier, such as identification information for an age-restricted sale.

The chosen transaction control command is then transmitted, via the site controller, to the appropriate self-checkout terminal. The transaction control command then configures the self-checkout terminal accordingly. For instance, an “approve” command approves the sale of an age-restricted item, while an “attend” command generates a notification that a staff member is on their way to provide assistance. The site controller can also rout transaction status updates and transaction control commands to and from a handled terminal in a similar manner as the point-of-sale device. Further, the site controller can generate transaction records based on the self-checkout terminals, the point-of-sale devices, the transaction control commands, and/or the transaction status updates. The transaction records may be transmitted to store manager device, which may be located remotely relative to the other aspects of the self-checkout monitoring device.

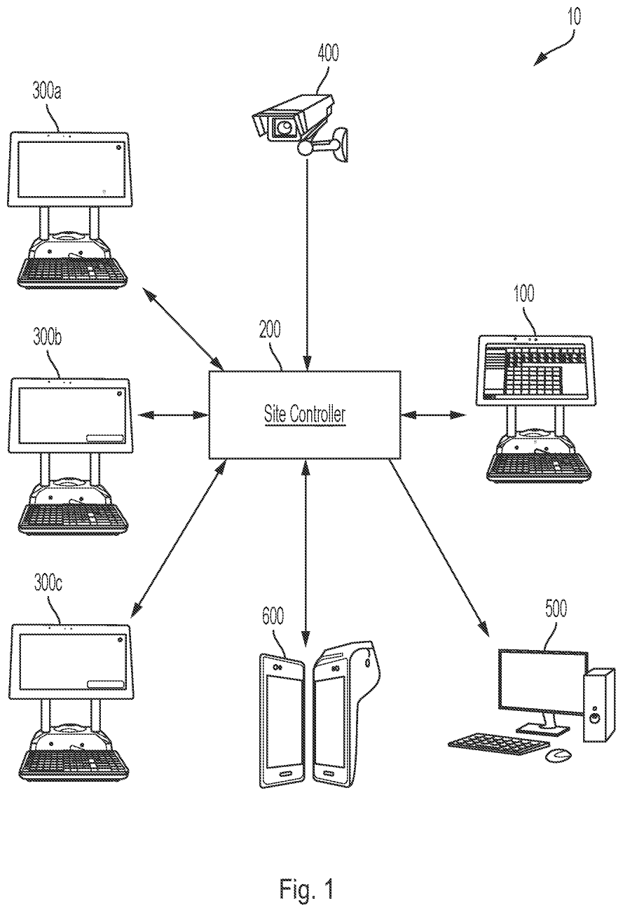

FIG. 1 is an diagram of an example of a self-checkout monitoring system 10. As shown in FIG. 1, the self-checkout monitoring system 10 includes several self-checkout terminals 300a, 300b, 300c, and a point-of-sale-device 100. In further examples, the self-checkout monitoring systems 10 can include any number of self-checkout terminals 300 and point-of-sale devices 100. For example, a store may have a bank of eight self-checkout terminals 300 located near the exit of the building. The store may also have a row of four checkout aisles, each checkout aisle having its own point-of sale device 100 to be operated by a cashier. The checkout aisles may be located a significant distance away from the self-checkout terminals 300. In this arrangement, the cashiers rely on information received by their corresponding point-of-sale device 100 to monitor and respond to activity occurring at the self-checkout terminals 300.

The self-checkout terminals 300 and the point-of-sale device 100 exchange information via site controller 200. The site controller 200 may be communicatively coupled to the self-checkout terminals or the point-of-sale device 100 via wired or wireless connection. The site controller 200 may be located locally relative to some or all the self-checkout terminals 300 and/or point-of-sale devices 100, or it may be located remotely.

According to an example, a self-checkout terminal 300a receives a transaction event 304 from a customer. The transaction event 304 may correspond to a wide array of actions, including purchasing a standard, unrestricted item, inserting a payment card, entering customer information (such as a phone number or e-mail address), for example. Alternatively, the transaction event 304 could include an action requiring staff intervention, such as a help request or a purchase of an age-restricted item (such as alcohol or tobacco products). An age-restricted sale may require a staff member to verify the customer's age, such as be viewing a photo identification document (driver's license, passport, etc.). The self-checkout terminal 300a may prevent the customer from completing their transaction until the staff member has verified their age. The self-checkout terminal 300a may treat a help request (such as question regarding use of the self-checkout terminal or a request to void an incorrectly scanned item) similar to an age restricted sale by preventing the customer from completing their transaction until a staff member clears the help request from their self-checkout terminal. Currently, the staff member may be alerted to the age-restricted sale or help request via a physical alert from self-checkout terminal 300 itself, such as by an illuminated or blinking light. The staff member may clear the age-restricted sale or help request by interacting with the interface of the self-checkout terminal 300, and may be required to enter identifying information, such as an employee number. The provided self-checkout monitoring system 10 allows for staff to receive and respond to such requests more quickly and efficiently.

The self-checkout terminal 300 generates a transaction status update 302 based on this transaction event 304 and the corresponding self-checkout terminal 300. The transaction status update 302 comprises information regarding the transaction event 304. This information can include the type of the transaction event 304 (standard item sale, age-restricted sale, help request), product name 116, product quantity 118, amount due 120, etc. The transaction status update 302 also includes information identifying the originating self-checkout terminal 300, such as a MAC address, serial number, register identification, or other identifying information.

The self-checkout terminal 300 then transmits the transaction status update 302 to the site controller 200. The self-checkout terminal 300 may transmit the transaction status update 302 via a wired connection. Alternatively, the self-checkout terminal 300 may wirelessly transmit the transaction status update 302, such as via a transceiver 380.

The site controller 200 routes the transaction status update 302 to one or more point-of-sale devices 100. The site controller 200 may transmit the transaction status update 302 via a wired connection. Alternatively, the site controller 200 may wirelessly transmit the transaction status update 302, such as via a transceiver 280.

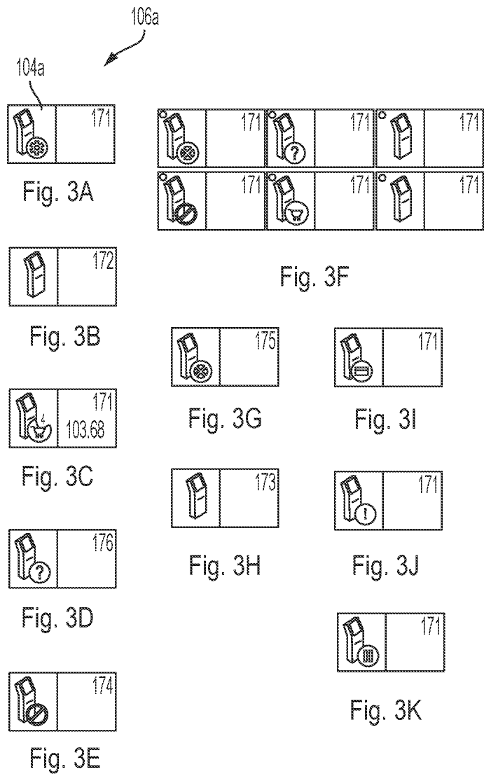

Upon receiving the transaction status update 302, the point-of-sale device 100 generates a transaction status icon 104 based on the transaction status update 302. The transaction status icons 104 allow the cashier operating the point-of-sale device 100 to quickly ascertain the most recent transaction event 304 (standard item sale, restricted item sale, help request, etc.) at the corresponding self-checkout terminal 300. Example transaction status icons 104 are shown in FIGS. 3A-3K.

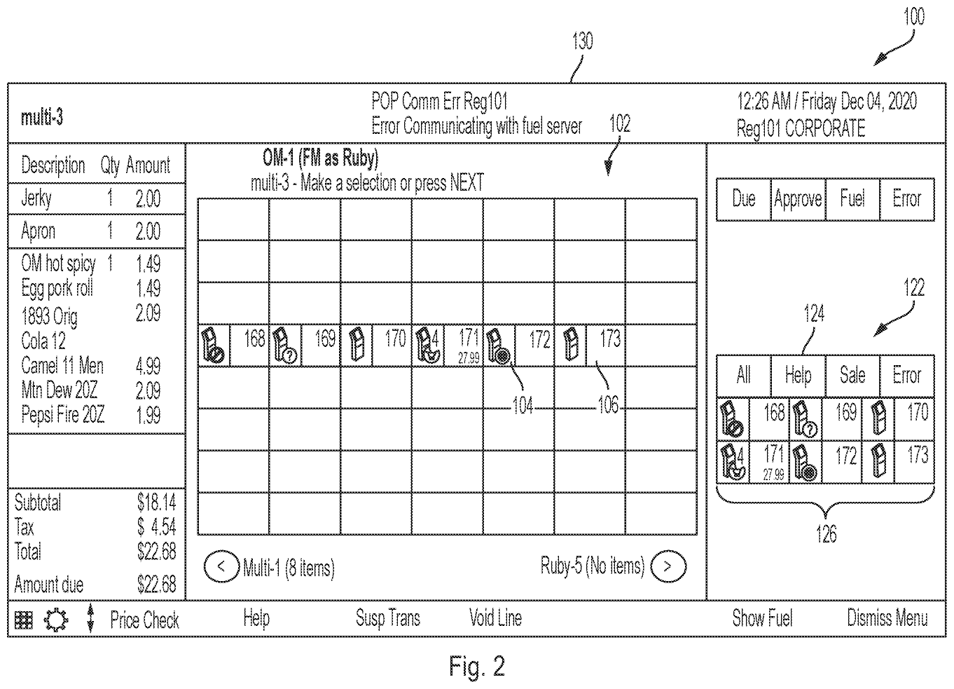

The point-of-sale device 100 displays a self-checkout monitoring panel 102 with a plurality of status tiles 106. An example self-checkout monitoring panel 102 is shown in FIG. 2. Each status tile 106 corresponds to a self-checkout terminal 300 in the self-checkout monitoring system 10. Further, each status tile 106 displays the status icon 104 corresponding to the transaction status update 302 most recently received from the corresponding self-checkout terminal 300. Each status tile 106 also includes an identifier for the corresponding self-checkout terminal 300, such as an identification number. Accordingly, the self-checkout monitoring panel 102 enables a cashier to determine the status of every self-checkout terminal 300 quickly and easily.

The self-checkout monitoring panel 102 also enables the cashier to control aspects of the self-checkout terminals 300 from the point-of-sale device 100. The cashier can select one of the status tiles 106 corresponding to a self-checkout terminal 300 by entering a self-checkout terminal selection input 108. If the self-checkout monitoring panel 102 is displayed on a touch screen, the self-checkout terminal selection input 108 may be simply touching the displayed status tile 106 corresponding to the self-checkout terminal 300. Alternatively, the self-checkout selection input 108 may be one or more keystrokes received through a keyboard or keypad, a mouse click received through a mouse, a voice command received by a microphone, or any other practical input received by a peripheral device of the point-of-sale terminal 100.

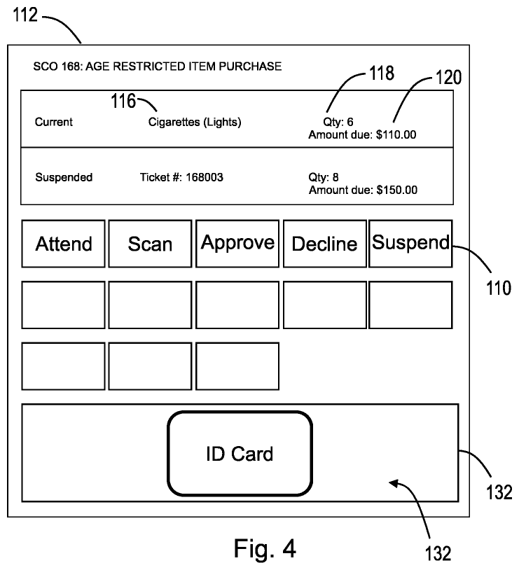

This self-checkout terminal selection input 108 causes the point-of-sale device 100 to display a detail view panel 112, as shown in FIG. 4. The detail view panel 112 displays a plurality of transaction control commands 110, such as attend, approve, decline, and/or suspend. The detail view panel 112 can also contain additional information relevant to the corresponding transaction status update 302, such as product name 116, product quantity 118, and/or amount due 120. In this example, the amount due 120 can be the product price multiplied by the product quantity, plus or minus any additional fees and/or discounts. Accordingly, if the cashier operating the point-of-sale device 100 notices that the status tile 106 corresponding to self-checkout terminal 300 indicates an age-restricted sale, the cashier may choose “attend” to allow them to walk over to the self-checkout terminal 300 to verify the age of the customer. Alternatively, the cashier may decide to “approve” or “decline” the age-restricted sale according to store policy or their own discretion.

The cashier can then choose a transaction control command 110 by entering a transaction control command selection 114. Similar to the self-checkout terminal selection input 108, the transaction control command selection 114 may be made by touching the displayed transaction control command 110. Alternatively, the transaction control command selection 114 may be one or more keystrokes received through a keyboard or a keypad, a mouse click received through a mouse, a voice command received by a microphone, or any other practical input received by a peripheral device of the point-of-sale terminal 100.

The point-of-sale device 100 then transmits, via wired or wireless connection, the transaction control command 110 to the site controller 200. The site controller 200 then transmits, via wired or wireless connection, the transaction control command 110 to the corresponding self-checkout terminal 300. Upon receipt, the self-checkout terminal 300 is configured according to the transaction control command 110. For example, if the transaction control command 110 corresponds to “decline,” the purchase (such as an age-restricted sale) will be cancelled.

As shown in FIG. 1, the example self-checkout monitoring system 300 also includes a camera 400. The camera 400 is positioned to monitor at least one of the self-checkout terminals 300 and provide corresponding image data 402, such as still images or video, to the site controller 200. The site controller 200 may then provide the image data 402 to the point-of-sale device 100. The point-of-sale device 100 can then display the image data 402 to the cashier. In one example, and as shown in FIG. 4, the image data is displayed in the detail view panel 112. The cashier can then use this image data 402 to select an appropriate transaction control command 110. For example, the camera 402 may be used to provide information to the cashier, such as identification information for an age-restricted sale. Upon viewing the identification information, the cashier can decide whether to approve or decline the age-restricted sale.

In a further example, and as shown in FIG. 1, the self-checkout monitoring system 10 may include a handheld terminal 600. The handheld terminal 600 may be operated by a roaming staff member tasked with monitoring several self-checkout terminals 300. The site controller 200 can route transaction status updates 102 and transaction control commands 110 to and from the handled terminal 600. Further, in a similar manner as the point-of-sale device 100, the handheld terminal 600 may be configured to display transaction status icons 104 and/or status tiles 106 corresponding to the self-checkout terminals 300, and also generate transaction control commands 100 to configure the self-checkout terminals 300.

Further, the site controller 200 can generate transaction records 202 based on the self-checkout terminals 300, the point-of-sale devices 100, the transaction control commands 110, and/or the transaction status updates 102. An example transaction record 202 may log an identification number of the self-checkout terminal 300 undergoing an age-restricted sale, the transaction status update 102 generated in response to the age-restricted sale, the point-of-sale device 100 approving the age-restricted sale, and the transaction control command 110 corresponding to the approval. Transaction records 202 may contain additional relevant information, such as date and time, customer identification, cashier identification, store identification, and product information.

In a further example, and as shown in FIG. 1, the self-checkout monitoring system 10 may include a store manager device 500, such as a personal computer. The site controller 200 may transmit, wired or wirelessly, the transaction records 202 to the store manager device 500 for storage and/or further analysis. The store manager device 500 may be located remotely relative to the other aspects of the self-checkout monitoring device 10.

FIG. 2 is an illustration of a display screen 130 of a point-of-sale device 100. The point-of-sale device 100 is most typically used to total the items a customer wishes to purchase and to facilitate payment of those items, the leftmost section of the display screen 130 shows the items to be purchased by a customer, along with a running total amount due. The center section of the display screen 130 shows the self-checkout monitoring panel 102. The cashier may use the arrow icons below the self-checkout monitoring panel 102 to switch to other types of panels, such as a panel displaying detailed information of the items listed in the leftmost section. The displayed self-checkout monitoring panel 102 allows the cashier to monitor self-checkout terminals 100 numbered 168-173. The self-checkout monitoring panel 102 includes a plurality of status tiles 106, and each status tile 106 displays a status icon 104 and an identification number of the corresponding self-checkout terminal. For example, the status icon 104 of self-checkout terminal 100 number 169 indicates a help request from the customer.

The rightmost section of the display screen 130 includes a utility panel 122. The utility panel 122 displays a subset 126 of the status tiles 106 displayed in the self-checkout monitoring panel 102. The status tiles 106 comprising the subset 126 are chosen based on selectable filter tiles 124. For example, if “ALL” is selected, the subset 126 includes all of the status tiles 106 shown in the self-checkout monitoring panel 102. If “HELP” is selected, the subset 126 includes only the status tiles 106 corresponding to a help request, such as the status tile 106 corresponding to self-checkout terminal 100 number 169. The utility panel 122 may be displayed on the display screen 130 even if the cashier has used the arrow buttons to hide the self-checkout monitoring panel 102, thus enabling more robust monitoring.

FIGS. 3A-3K are illustrations of various status tiles 106, each status tile 106 including a transaction status icon 104, in accordance with several examples. FIG. 3A shows a transaction status icon 104 indicating the self-checkout terminal 300 is in a configuration or log-in mode, and is not ready to checkout a customer. FIG. 3B indicates the self-checkout terminal 300 is ready for use by a customer. FIG. 3C indicates the customer has begun checking out at the self-checkout terminal, and has four items in their cart totaling $103.58. FIG. 3D indicates the customer is requesting help from a staff member. FIG. 3E indicates an attempted age restricted sale. FIG. 3F shows a series of status icons 104 with a dot in the upper right corner. The dot indicates that a cashier has logged into the self-checkout terminal 300 to assist the customer or perform other tasks. FIG. 3G indicates the self-checkout terminal 300 is closed. The faded appearance of FIG. 3H indicates that the self-checkout terminal 300 is offline. FIG. 3I indicates the customer has begun the payment process, while FIG. 3J indicates the payment has failed. FIG. 3K indicates the transaction at the self-checkout terminal 300 has been suspended. Other transaction status icons 104 may be implemented depending on the application.

FIG. 4 is an illustration of a detail view panel 112 as shown on a display screen 130 of a point-of-sale device 100. As can be seen in the upper right corner, the detail view panel 112 corresponds to self-checkout terminal 100 number 168. The detail view panel 112 can be accessed by selecting the status tile 106 in the self-checkout monitoring panel 102 corresponding to self-checkout terminal 100 number 168. Alternatively, the detail view panel 122 can be accessed by selecting the status tile 106 in the utility panel 122 corresponding to self-checkout terminal 100 number 168. As shown in FIG. 4, the detail view panel 112 indicates the customer has attempted an age-restricted purchase of cigarettes. The cashier operating the point-of-sale device 100 has the option to select a transaction control command 110, such as attend, scan, approve, decline, or suspend. The detail view panel 112 further includes an image view window 132 configured to display the image data 402 captured by the camera 400. In this example, the customer has held his ID card up to the camera 400 so that the cashier may verify his age to approve the transaction.

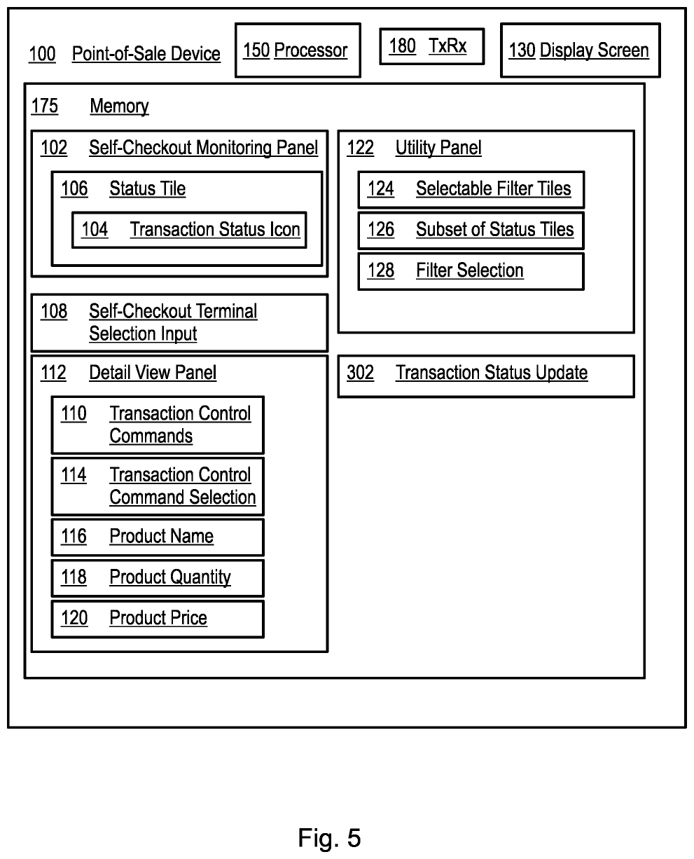

FIG. 5 is a schematic diagram of a point-of-sale device 100. As shown in FIG. 5, the point-of-sale device 100 includes a display screen 130, a processor 150, a memory 175, and a transceiver 180. Broadly, the point-of-sale device 100 receives, via the site controller 200, transaction status updates 302 from various self-checkout terminals 200. The point-of-sale device 100 then displays, on the display screen 130, transaction status icons 104 and status tiles 106 based on the transaction status updates 302. The point-of-sale device 100 receives the transaction status updates 302, then generates and transmits transaction control commands 110 to the self-checkout terminals 300 based on transaction control command selections 114 received from the cashier. In some examples, the display screen 130 is a touch-sensitive screen.

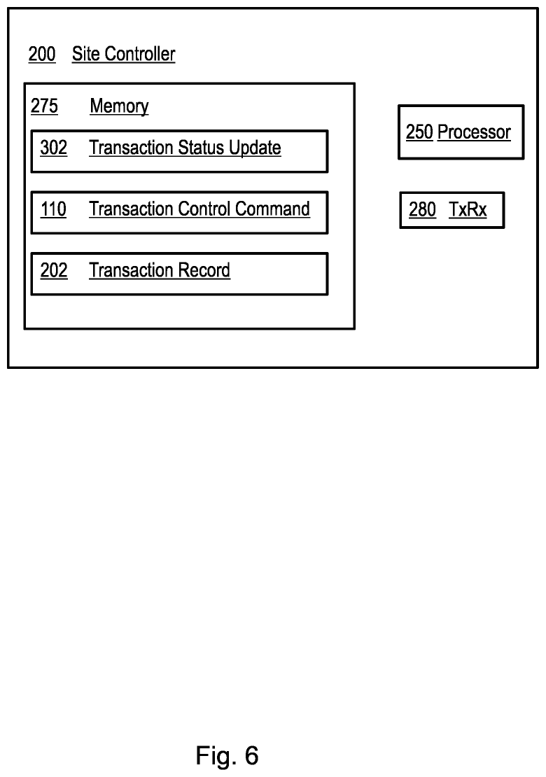

FIG. 6 is a schematic diagram of a site controller 200. As shown in FIG. 6, the site controller 200 includes a processor 250, a memory 275, and a transceiver 280. Broadly, the site controller 200 is configured to route transaction status updates 302 from the self-checkout terminals 300 to the point-of-sale devices 100 and/or the handheld terminals 600. The site controller 200 is further configured to route transaction control commands 110 from the point-of-sale devices 100 and/or the handheld terminals 600 to the self-checkout terminals 300. The site controller 200 may be further configured to generate transaction records 202, and transmit those transaction records 202 to a store manager device 500.

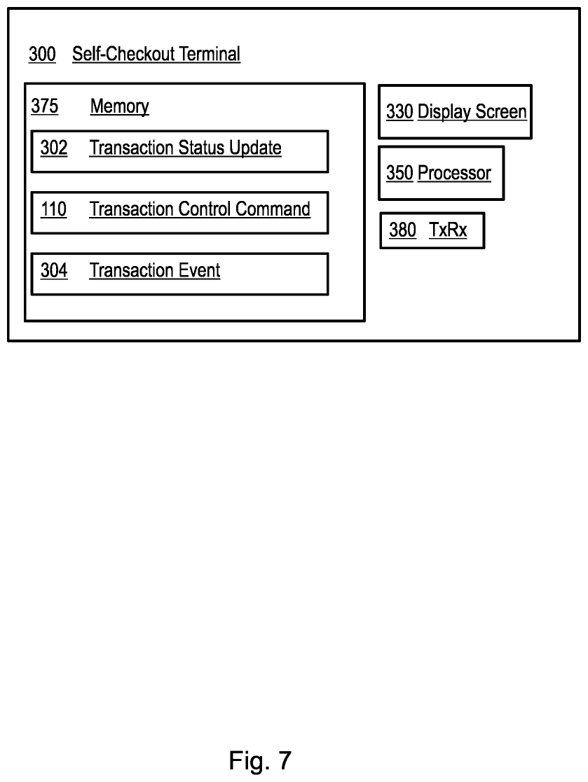

FIG. 7 is a schematic diagram of a self-checkout terminal 300, in accordance with an example. As shown in FIG. 7, the self-checkout terminal 300 includes a processor 350, a memory 375, a transceiver 380, and a display screen 390. Broadly, the self-checkout terminal 300 is configured to receive transaction events 304 from the customer, and generate corresponding transaction status updates 302. The transceiver 380 of the self-checkout terminal 300 transmits the transaction status update 302 to the site controller 200, which forwards the transaction status update 302 onto the point-of-sale device 100. The transceiver 380 of the self-checkout terminal 300 receives, via the site controller 200, transaction control commands 110 from the point-of-sale device 100. The processor 350 then configures various aspects of the self-checkout terminal 300 according to the received transaction control commands 110. In some examples, the display screen 330 is a touch-sensitive screen.

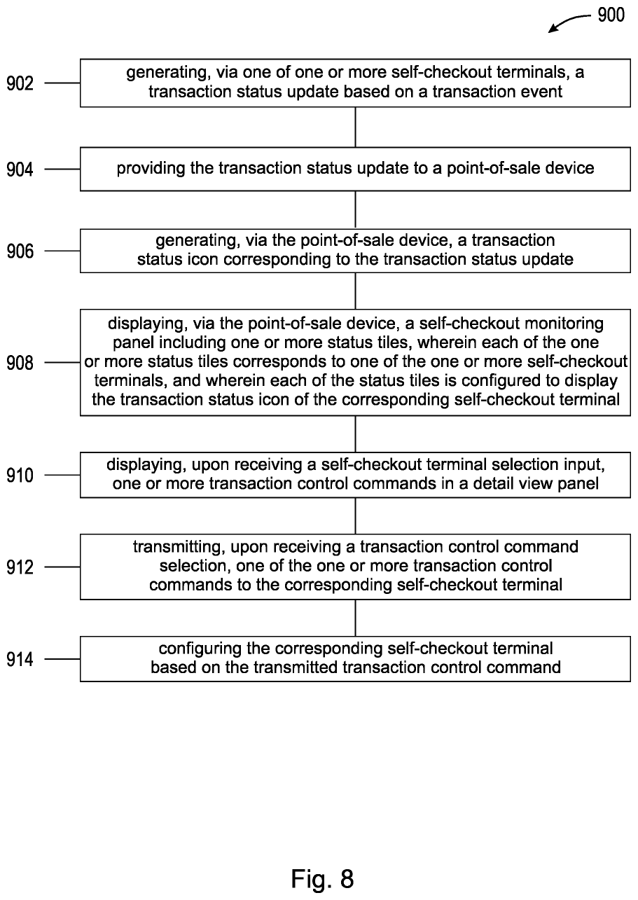

FIG. 8 is a flowchart of a method 900 for self-checkout monitoring. The method 900 includes generating 902, via one of one or more self-checkout terminals, a transaction status update based on a transaction event. The method 900 further includes providing 904 the transaction status update to a point-of-sale device. In one example, the transaction status update is routed from the self-checkout terminal to the point-of-sale device by a site controller. The method 900 further includes generating 906, via the point-of-sale device, a transaction status icon corresponding to the transaction status update. The method 900 further includes displaying 908, via the point-of-sale device, a self-checkout monitoring panel including one or more status tiles, wherein each of the one or more status tiles corresponds to one of the one or more self-checkout terminals, and wherein each of the status tiles is configured to display the transaction status icon of the corresponding self-checkout terminal. The method 900 further includes displaying 910, upon receiving a self-checkout terminal selection input, one or more transaction control commands in a detail view panel. The method 900 further includes transmitting 912, upon receiving a transaction control command selection, one of the one or more transaction control commands to the corresponding self-checkout terminal. The method 900 further includes configuring 914 the corresponding self-checkout terminal based on the transmitted transaction control command.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A point-of-sale device comprising a processor configured to:
receive a transaction status update corresponding to one of one or more self-checkout terminals;
generate a transaction status icon corresponding to the transaction status update;
display a self-checkout monitoring panel comprising one or more status tiles, wherein each of the one or more status tiles corresponds to one of the one or more self-checkout terminals, and wherein each of the status tiles is configured to display the transaction status icon of the corresponding self-checkout terminal;
display, upon receiving a self-checkout terminal selection input, one or more transaction control commands in a detail view panel; and
transmit, upon receiving a transaction control command selection, one of the one or more transaction control commands to the corresponding self-checkout terminal.

2. The point-of-sale device of claim 1, wherein the transaction status update is one of non-sales, idle, customer check-in, sales, help request, help request and sales, age restricted sale, cashier log-in, lane closed, offline, payment failure, and suspended.

3. The point-of-sale device of claim 1, wherein the one or more transaction control commands include at least one of attend, scan, approve, decline, and suspend.

4. The point-of-sale device of claim 1, wherein the detail view panel further comprises at least one of product name, product quantity, and amount due.

5. The point-of-sale device of claim 1, wherein the processor receives the transaction status update via a site controller.

6. The point-of-sale device of claim 1, wherein the processor is further configured to receive image data corresponding to one of the one or more self-checkout terminals.

7. The point-of-sale device of claim 6, wherein the detail view panel further comprises at least a portion of the image data.

8. The point-of-sale device of claim 1, wherein the processor is further configured to display a utility panel, wherein the utility panel is configured to display:
one or more selectable filter tiles; and
a subset of the status tiles displayed in the self-checkout monitoring panel, wherein the subset of the status tiles are displayed according to a filter selection corresponding to one of the one or more selectable filter tiles.

9. A self-checkout monitoring system comprising one or more self-checkout terminals, a site controller, and one or more point-of-sale devices, wherein the site controller comprises a processor configured to:
receive a transaction status update corresponding to a first self-checkout terminal;
transmit the transaction status update to each of the one or more point-of-sale devices;
receive a transaction control command from a first point-of-sale device; and
transmit the transaction control command to the first self-checkout terminal.

10. The self-checkout monitoring system of claim 9, wherein the processor of the site controller is further configured to generate a transaction record corresponding to the transaction control command, the first self-checkout terminal, and the first point-of-sale device.

11. The self-checkout monitoring system of claim 10, wherein the processor of the site controller is further configured to transmit the transaction record to a store manager device.

12. The self-checkout monitoring system of claim 11, wherein the store manager device is located remotely relative to the one or more self-checkout terminals and the one or more point-of-sale devices.

13. The self-checkout monitoring system of claim 9, wherein the processor of the site controller is further configured to transmit the transaction status update to a handheld terminal.

14. The self-checkout monitoring system of claim 13, wherein the processor of the site controller is further configured to:
receive a handheld transaction control command from the handheld terminal; and
transmit the handheld transaction control command to the first self-checkout terminal.

15. The self-checkout monitoring system of claim 14, wherein the processor of the site controller is further configured to generate a transaction record corresponding to the handheld transaction control command, the first self-checkout terminal, and the handheld terminal.

16. The self-checkout monitoring system of claim 9, further comprising a camera configured to provide image data corresponding to the first self-checkout terminal to the site controller, wherein the processor of the site controller is further configured to provide the image data to the first point-of-sale device.

17. A self-checkout terminal comprising a processor configured to:
generate a transaction status update based on a transaction event;
provide the transaction status update to a site controller;
receive, from the site controller, a transaction control command corresponding to the transaction status update; and
configure the self-checkout terminal based on the transaction control command.

18. The self-checkout terminal of claim 17, wherein the site controller receives the transaction control command from a point-of-sale device.

19. The self-checkout terminal of claim 17, wherein the transaction event is an age-restricted sale.

20. The self-checkout terminal of claim 17, wherein the transaction event is a help request.
